(19) United States
(12) Patent Application Publication
(10) Pub. No.: US 2023/0380316 A1
(43) Pub. Date: Nov. 30, 2023

(54) SYSTEMS, APPARATUS, AND RELATED METHOD FOR REMOTE ADJUSTMENT OF MACHINERY

(71) Applicant: KUHN KRAUSE, INC.

(72) Inventors: Andrew A. POPE, Wichita, KS (US); Matthew Z. PILGREEN, Haven, KS (US); Peter J. GOODGE, Wichita, KS (US)

(73) Assignee: KUHN KRAUSE, INC., Hutchinson, KS (US)

(21) Appl. No.: 17/828,666

(22) Filed: May 31, 2022

(51) Int. Cl. A01B 33/08; A01B 33/02; A01B 63/111

(52) U.S. Cl. CPC A01B 33/087; A01B 33/024; A01B 63/111

(57) ABSTRACT

Systems, apparatus, and methods for remotely adjusting implements with preset profiles are described. A disclosed method for processing a material on a ground surface includes receiving a transmitted monitored set of parameters of the first set of material manipulators and the second set of material manipulators; determining whether the first set of material manipulators or the second set of material manipulators is within a predetermined range of a parameter setpoint; and upon determining the first set of material manipulators or the second set of material manipulators is not within the predetermined range of the parameter setpoint, actuating the first set of actuators to adjust the first set of material manipulators or the second set of actuators to adjust the second set of material manipulators, wherein actuating the first set of actuators or the second set of actuators can be performed independently.

### BACKGROUND

### Field of the Disclosure

The present disclosure relates to agricultural equipment adjustment. More precisely, the present application relates to a method of adjusting agricultural equipment remotely without the need to perform an operation physically and manually in order to set or change an equipment setting.

### Description of the Related Art

While agricultural equipment can be adjusted, often a manual adjustment requiring a user to exit a cab of a vehicle needs to be carried out. For example, an operator may have to get out of a tractor cab to turn handles and knobs, tighten bolts, pull pins, and even push or pry heavy components into a position where they can be pinned solid and fixed. This can be particularly challenging for the user if the equipment is complex, heavy, and difficult to articulate.

Some partial solutions include ISOBUS connectivity to monitor values of certain features and perform their adjustments, but in the end the user may skip adjustment altogether unless a serious issue arises, especially if only a portion of the equipment can be adjusted remotely and the remainder needs to be adjusted by hand, or if the remote adjustment is too complex. This can lead to less optimal implementation of the equipment in the field since work performed in a predetermined area may not be optimally tuned for that particular area. That is, the user may decide the time and effort to perform an adjustment is not worth the marginal return in results. Further, for particularly complex equipment, the ISOBUS connectivity may still require tedious adjustment even remotely to address each component, again leading to the user not executing the adjustment process or an unskilled user performing the adjustment process incorrectly.

Some solutions may not be ISOBUS certified, meaning the solution will not be able to connect with any manufacture's ISOBUS equipment. This can lead to a more cluttered vehicle cab if more equipment (e.g., monitors, etc.) is needed to obtain full functionality of all the equipment, or equipment becoming prematurely outdated if the equipment cannot be constantly updated.

Accordingly, a method for remotely tuning an entire tool with various setting controls and pre-set adjustment profiles is desired.

### SUMMARY

Accordingly, the object of the present disclosure is to provide a method for remotely tuning an entire tool with various setting controls and pre-set adjustment profiles.

The present disclosure relates to a method, including receiving, from the implement including a first set of material manipulators configured to manipulate the material on the ground surface, a second set of material manipulators being independently adjustable from the first set of material manipulators and configured to manipulate the material on the ground surface, a first set of sensors configured to monitor a set of parameters of the first set of material manipulators, a second set of sensors configured to monitor a set of parameters of the second set of material manipulators, a first set of actuators configured to adjust the set of parameters of the first set of material manipulators, and a second set of actuators configured to adjust the set of parameters of the second set of material manipulators, a transmitted monitored set of parameters of the first set of material manipulators and the second set of material manipulators; determining whether the first set of material manipulators or the second set of material manipulators is within a predetermined range of a parameter setpoint; and upon determining the first set of material manipulators or the second set of material manipulators is not within the predetermined range of the parameter setpoint, actuating the first set of actuators to adjust the first set of material manipulators or the second set of actuators to adjust the second set of material manipulators, wherein actuating the first set of actuators or the second set of actuators can be performed independently.

The present disclosure additionally relates to a system, including an implement including a first set of material manipulators configured to manipulate the material on the ground surface, a second set of material manipulators being independently adjustable from the first set of material manipulators and configured to manipulate the material on the ground surface, a first set of sensors configured to monitor a set of parameters of the first set of material manipulators, a second set of sensors configured to monitor a set of parameters of the second set of material manipulators, a first set of actuators configured to adjust the set of parameters of the first set of material manipulators, and a second set of actuators configured to adjust the set of parameters of the second set of material manipulators, and a first device disposed in a vehicle, the vehicle mechanically and electrically coupled to the implement, the first device communicatively coupled to the first set of sensors, the second set of sensors, the first set of actuators, and the second set of actuators, the first set of sensors and the second set of sensors configured to transmit the monitored set of parameters to the first device, the first device including processing circuitry configured to receive, from the implement, the transmitted monitored set of parameters of the first set of material manipulators and the second set of material manipulators, determine whether the first set of material manipulators or the second set of material manipulators is within a predetermined range of a parameter setpoint, and upon determining the first set of material manipulators or the second set of material manipulators is not within the predetermined range of the parameter setpoint, actuate the first set of actuators to adjust the first set of material manipulators or the second set of actuators to adjust the second set of material manipulators, wherein actuating the first set of actuators or the second set of actuators can be performed independently.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of a system including an electronic device, such as a client/user device (a first device) communicatively connected to an apparatus, such as a tillage implement (a second device), according to an embodiment of the present disclosure.

FIG. 2 is a schematic of a tillage implement, according to an embodiment of the present disclosure.

FIG. 3A is a flow chart for a method of monitoring and adjusting a depth of the second device, according to an embodiment of the present disclosure.

FIG. 3B is a schematic showing the circuit diagram for the depth control process, according to an embodiment of the present disclosure.

FIG. 4 is a flow chart for a method of monitoring and adjusting the front gangs and the rear gangs of the second device, according to an embodiment of the present disclosure.

FIG. 5 is a flow chart for a method of monitoring and adjusting the star wheels of the second device, according to an embodiment of the present disclosure.

FIG. 6 is a flow chart for a method of monitoring and adjusting the level of the second device, according to an embodiment of the present disclosure.

FIG. 7A is a flow chart for a method of monitoring and adjusting the wing down pressure, according to an embodiment of the present disclosure.

FIG. 7B is a schematic showing the circuit diagram for the wing down pressure control process, according to an embodiment of the present disclosure.

FIG. 8 is a flow chart for a method of setting preset settings and locking out a user, according to an embodiment of the present disclosure.

FIG. 9 is a block diagram of a hardware description of a computer used in exemplary embodiments.

FIG. 10 is a schematic diagram of an exemplary data processing system, according to an embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The order of discussion of the different steps as described herein has been presented for clarity sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Tillage operations have long been thought of as a relatively simple task, while planting harvesting and fertilizing have been thought of as more complex tasks requiring more sophisticated technology in order to be more efficient and achieve higher profits. However, in recent years, the need for smarter, more efficient, and easier-to-use tillage tools have been in higher demand.

The ability to perform quick adjustments to tillage implements while working in the field can provide a user with an ability to deliver a prescription tillage operation entirely from a cab of a tractor or other vehicle. Thus, described herein is a system and method for remotely tuning a tillage implement with various setting controls and pre-set adjustment profiles.

Previously, the user would have to exit the tractor cab and manually articulate components on the implement, which can be complex and heavy. This can be a labor-intensive and time-consuming process, and with the various tasks that must be carried out in a working day around the farm or work site, it is not uncommon for the users of tillage implements to forgo the adjustment process except when absolutely necessary to avoid the most serious of problems.

Being able to perform adjustments to an implement while on the go can allow the user to optimize the equipment for the task and account for different soil types and conditions that change throughout the field. For example, if one part of a field has significantly more moisture than another part, the user can change their implement settings that would be desirable for wet conditions, and then quickly switch the settings back to a normal field condition as the unit moves out of the wet field condition. This would likely be ignored by the user without the ability to change settings on the go from the cab using a remote system, as the benefit of changing the settings for a specific situation would have to be weighed with the expense of stopping the tractor and getting out to make the necessary adjustments, and then start working again, only to change the settings back after the unique area was worked. Therefore, the manual adjustment method can be impractical in most real-world situations.

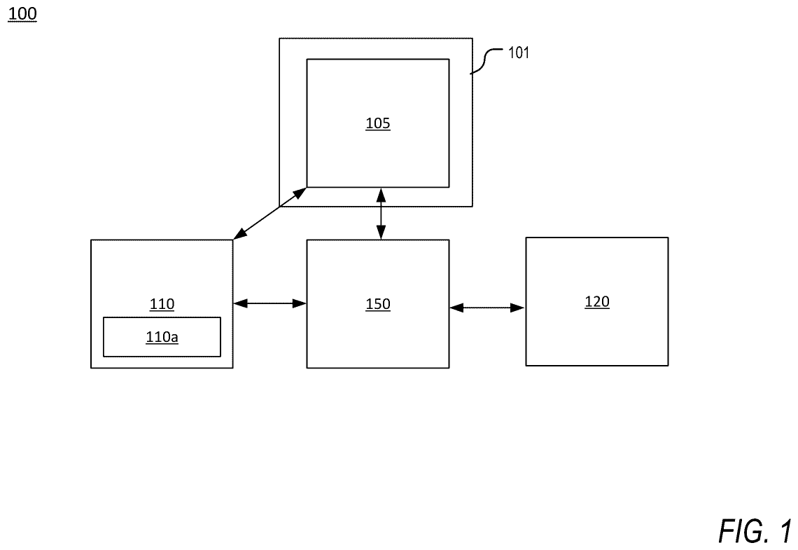

To this end, FIG. 1 is a schematic view of a system 100 including an electronic device, such as a client/user device (a first device 105) communicatively connected to an apparatus, such as a tillage implement (a second device 110), according to an embodiment of the present disclosure. Notably, the first device 105 can be communicatively connected via a network 150, to a second electronic device, such as a server (a networked device 120). The devices can be connected via a wired or a wireless network. The connection between, for example, the first device 105 and the server can preferably be via the wireless network. In one embodiment, the first device 105 can be responsible for obtaining data from the second device 110 and transmitting the data over the communication network 150 to the networked device 120.

An application may be installed or accessible on the first device 105 for executing the methods described herein. The application may also be integrated into an operating system (OS) of the first device 105. The first device 105 can be any electronic device such as, but not limited to, a personal computer, a tablet pc, a smart-phone, a smart-watch, a smart-television, an interactive screen, an IoT (Internet of things) device, or the like.

For example, the first device 105 can be a computer included in a cab of a tractor 101 attached to the second device 110, which can be the tillage implement, wherein the second device 110 can include a plurality of sensors 110a configured to monitor parameters of the tillage implement and transmit the obtained data to the first device 105. The first device 105 can receive the data from the second device 105 and analyze the received data, or the second device 110 can also be communicatively connected to the networked device 120 and the second device 110 can transmit the data to the networked device 120. The first device 105 can also be configured to transmit data and instructions to the second device 110. For example, the second device 110 can include a plurality of actuators configured to adjust features of the second device 110. In an embodiment, the networked device 120 can also transmit data and instructions to the first device 105 to relay to the second device 110, or transmit directly to the second device 110. In an embodiment, the first device 105 can be an ISOBUS monitor, wherein data can be shared or transmitted between the tractor 101, the ISOBUS monitor, and the second device 110. For example, radar, LIDAR, IR, or GPS signals can be transmitted and control of the tractor 101 and the second device 110 can be performed via the ISOBUS monitor.

In an embodiment, the second device 110 further includes a control valve and an electronic control unit (ECU). A communication harness can connect the ECU to the ISOBUS monitor and an application may be installed or accessible on the ECU for executing the methods described herein. A control harness can connect the ECU to the control valve to control hydraulic functions of the second device 110. A sensor harness can connect the ECU to each sensor of the plurality of sensors 110a on the second device 110 and the control valve.

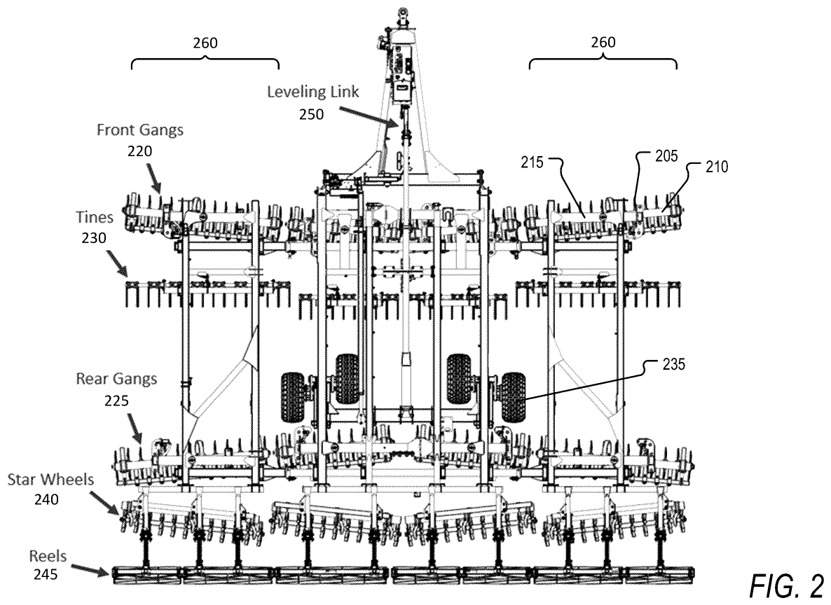

An example of the second device 110 is described herein. To this end, FIG. 2 is a schematic of a tillage implement, according to an embodiment of the present disclosure. In an embodiment, the second device 110 is the tillage implement and FIG. 2 shows a more detailed view of the tillage implement. The second device 110 can be used as a finishing tool and configured to perform Vertical Tillage (VT), or, that is, work at higher speeds and work the soil using vertically mounted blades 205 (as compared to a blade with a set angle). The blades 205 can be circular, serrated blades.

In an embodiment, the blades 205 can be attached to a tube 210 that is in turn connected to a frame 215 of the second device 110. Assemblies including the tube 210 and the series of blades 205 can be referred to as gangs. The second device 110 can include first or front gangs 220 and second or rear gangs 225. The front gangs 220 and the rear gangs 225 can span a width of the second device 110. The front gangs 220 can have a spacing of, for example, 4″ to 10″, or 6″ to 8″, or 7″ to 10″, or 6.5″ to 8.5″ between the blades 205, and the rear gangs 225 can have a spacing of, for example, 5″ to 11″, or 7″ to 9″, or 8″ to 11″, or 7.5″ to 8.5″ between the blades 205. The front gangs 220 and the rear gangs 225 can be slightly angled to a direction of travel of the tractor 101. The front gangs 220 can be angled such that the front gangs 220 throw the soil to an outside of the second device 110, while the rear gangs 225 can throw the soil back to the inside of the second device 110. This outside and inside soil throwing pattern can therefore result in a level field finish as the tractor 101 and the tillage implement (the second device 110) works through a field.

In an embodiment, the second device 110 can include tines 230 disposed between the front gangs 220 and the rear gangs 225. The tines 230 can span a width of the second device 110. The tines 230 can be configured to assist in breaking up larger clods of soil and arranging residue to be sized by the rear gangs 225 more effectively.

In an embodiment, the second device 110 can include wheels 235 that lift and lower the second device 110. The wheels 235 can be positioned behind the tines 230, but in front of the rear gangs 225.

In an embodiment, the second device 110 can include finishing attachments disposed behind the rear gangs 225. The second device 110 can include star wheels 240 and rolling baskets/reels 245. The star wheels 240 can be paddle shaped wheels that help break up any large soil clods that were created by the rear gangs 225 as well as help level the finish of the second device 110. Lastly, the rolling baskets 245 can trail the star wheels 240 to further break down soil clods and leave an even and level surface.

In an embodiment, the second device 110 can have many different widths. For example, the width of the second device 110 can range from 8 ft to 60 ft, or 10 ft to 50 ft, or 11 ft to 40 ft. For widths over 20 ft, the second device 110 can include two or more sections of the frame 215 that are called wings 260, wherein the wings 260 fold up for transport and storage purposes.

In an embodiment, there are many adjustments to parameters that can be made in order to obtain a desired field finish. A working depth of the second device 110 can be controlled hydraulically by the wheels 235 that can range from, for example, 0 to 4.5″. An angle of the front gangs 220 and an angle of the rear gangs 225 can also be adjustable from, for example, 1° to 8°. The front gangs 220 angle and the rear gangs 225 angle can be adjusted independently, or together depending on field conditions, soil type, and desired finish. The star wheels 240 can have a hydraulic down pressure applied to the star wheels 240, which can be adjusted depending on soil conditions and finish as well. The star wheels 240 can also be lifted out or away from contact with the soil all together if desired. This can be performed when working in extremely wet soil since the soil can tend to ball up around the star wheels 240, which can cause plugging and an undesirable field finish.

In an embodiment, another adjustment that can be made is the fore and aft levelness of the second device 110 via a leveling link 250. This adjustment can be made to account for different tractor 101 hitch heights as well as to control the weight distribution across the second device 110 from front to rear. This weight distribution can be adjusted for not only different hitch heights, but also different soil types and conditions in order to get a level soil finish.

In an embodiment, another adjustment that can be made is the hydraulic down pressure on the wing 260 sections of the second device 110 when the second device 110 includes wings 260. The adjustable down pressure can help to evenly distribute a weight of the second device 110 across the width of the second device 110 to ensure an even field finish. A change in this adjustment can be, again, due to different soil types and conditions. It may be appreciated that the hydraulic down pressure on the wing 260 sections of the second device 110 can be adjusted for the star wheels 240 as described previously, as well as the front gangs 220 and/or the rear gangs 225 independently as well.

It may be appreciated that many of the features developed on the tillage implement can also be used on other types of machines or implements. Adjustments such as the depth control, fore/aft leveling, and down pressure application can be incorporated into this other agricultural equipment.

As previously mentioned, to monitor the various parameters of the second device 110, the second device 110 can include the plurality of sensors 110a. In an embodiment, the depth of the second device 110 can be controlled by feedback from a rotary position sensor that is connected to two linkages that comprise a 4-bar linkage when combined with a hydraulic cylinder, and the frame 215 of the second device 110. The rotary position sensor can measure the relative distance of the wheels 235 from the frame 215 of the second device 110, which in turn correlates to the depth of the blades 205 in the soil. This linkage relationship can be specific for this application to ensure best resolution of the second device 110 occurs within a working depth range, as well as to provide a linear relationship between a position of the rotary position sensor and the working depth of the second device 110. A linear relationship can allow accurate and repeatable results using a single point calibration.

In an embodiment, the zero point, or ground level, can be determined using a calibration sequence that can be performed while the second device 110 is not being used for work. Upon determination of the zero point, the second device 110 can determine a position of the ground level relative to the frame 215. This is important for the second device 110 to know to ensure accurate depth measurements, and so that an active depth control circuit does not interfere with a lift/lower circuit. The lift/lower circuit can be activated using a selective control valve (SCV) lever inside the tractor 101 cab. When the second device 110 is being lowered into the ground, the depth adjustment circuit can become active, meaning the depth adjustment circuit can bring the unit to a predetermined depth set on a monitor viewed by the user in the cab. The movement can be performed with a proportional flow control valve, which means that the second device 110 can be lowered quicker when the second device 110 is positioned further away from a set point and gradually get slower as the second device 110 gets very close to the set point. The proportional flow control valve can help ensure that the control loop does not overshoot the target depth while also reacting quick enough to get to the set depth in a reasonable time.

In an embodiment, the lift/lower circuit can be configured to always be able to override the depth control circuit. This can ensure that the depth control circuit never works against the lift/lower circuit. When the second device 110 reaches the set depth, the second device 110 will not allow the lift/lower circuit to lower the second device 110 into the ground further than the set point on the monitor. While working, the depth can be controlled easily from the monitor. When the user needs to lift the second device 110 out of the ground, the user can use the SCV lever to lift the second device 110 out. As soon as the second device 110 is lifted beyond the calibrated ground level, the depth control circuit can be disabled until the second device 110 is returned proximal to the ground again.

In an embodiment, cylinders that control the wheels 235 can be plumbed in series from a center of the second device 110 out toward the wings 260 of the second device 110. Since the wheels 235 are plumbed in this way, sensors can be disposed on the outer most wings 260 of the second device 110. Thus, the sensors can monitor a depth cylinder position on both a first depth cylinder and a last depth cylinder in the series of cylinders. By comparing these sensor values relative to one another, the system 100 can detect any small amount of leakage between cylinder seals over time. This small amount of leakage between cylinders can cause the series of cylinders to become out of phase, meaning the cylinders may not be at the same position across the width of the second device 110. This can be an issue with cylinders plumbed in series. Therefore, a rephasing method/device can be included in any cylinder that is intended to be plumbed in series. This rephasing method/device can allow fluid to leak beyond the seal on purpose when the cylinder is either retracted fully or extended fully. This allows the system to be rephased when the cylinder, depending on the cylinder design, is either fully retracted or extended. Normally the user will only notice this problem after it has drastically been out of phase for quite some time. However, because the adjustment method described herein can detect this small amount of leaking of the cylinders, the system 100 can alert the user that the user should rephase the cylinders by lifting the second device 110 all the way out of the ground.

Another benefit of including two sensors on the system 100 is that if one sensor or part of the harness is damaged in some way to disable a sensor output, the second device 110 can still be used like normal as the system 100 can automatically switch to the redundant sensor and use its feedback for control of the depth system. In an embodiment, another sensor can also be incorporated into this circuit, such as radar, for a true frame-to-ground distance measurement, which would in turn provide a more accurate depth measurement. This can also be accomplished with an ultrasonic sensor. In an embodiment, LIDAR can be used to obtain accurate depth measurements as well as clod sizing, residue sizing, and residue coverage. Likewise, a camera could be used to get accurate depth clod and residue sizing and residue coverage. In an embodiment, a moisture sensor can also be included, as well as an organic matter sensor. These metrics can be measured and sent to the network device 120 for further analysis, which can provide correlation for fertilizer prescriptions, tillage maps, or for long term field health history. For example, these metrics can also be layered over current weather forecasts that would also be used in the determining method. For example, these metrics can also be layered over soil maps that would also be used in the determining method. These metrics can be associated with depth or one of the other adjustments of the second device 110, or preferably, all of the adjustments of the second device 110.

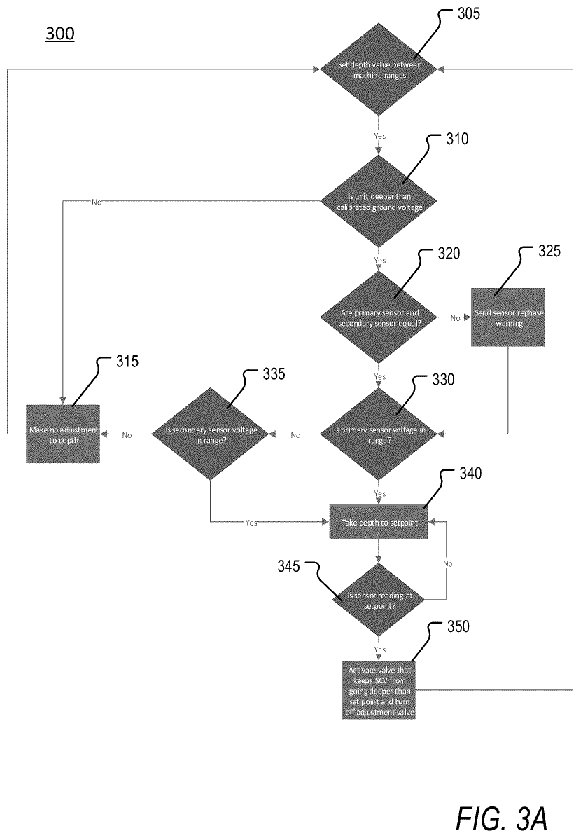

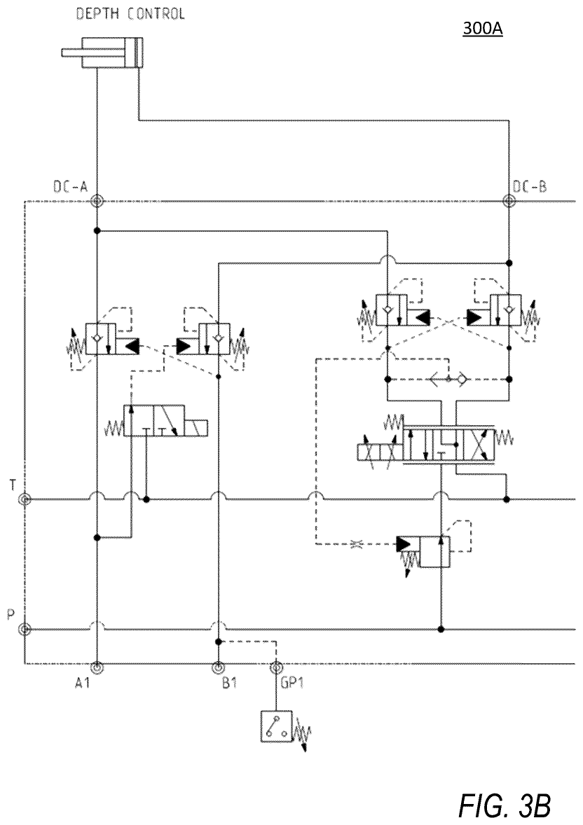

The depth adjustment can be further described with respect to FIG. 3A. FIG. 3A is a flow chart for a method 300 of monitoring and adjusting a depth of the second device 110, according to an embodiment of the present disclosure.

In an embodiment, in step 305, a depth value can be set between ranges of the second device 110.

In step 310, the first device 105 can determine whether the second device 110 is deeper than a calibrated ground voltage.

In step 315, upon determining the second device 110 is not deeper than the calibrated ground voltage, no adjustment may be made to the depth of the second device 110.

In step 320, upon determining the second device 110 is deeper than the calibrated ground voltage, the first device 105 can determine whether a primary sensor of the plurality of sensors and a secondary sensor of the plurality of sensors are equal in readings.

In step 325, upon determining the primary sensor of the plurality of sensors and the secondary sensor of the plurality of sensors are not equal in readings, the first device 105 can send a sensor rephase warning to the user.

In step 330, upon determining the primary sensor of the plurality of sensors and the secondary sensor of the plurality of sensors are equal in readings, the first device 105 can determine whether the primary sensor of the plurality of sensors is within range.

In step 335, upon determining the primary sensor of the plurality of sensors is not within range, the first device 105 can determine whether a secondary sensor voltage is within range. Upon determining the secondary sensor voltage is not within range, no adjustments to the depth are performed.

In step 340, upon determining the primary sensor of the plurality of sensors is within range, or upon determining the secondary sensor of the plurality of sensors is within range, the second device 110 depth can be taken to a setpoint set by the user.

In step 345, the first device 105 can determine whether the primary sensor or the secondary sensor is reading at the setpoint. Upon determining the primary sensor or the secondary sensor is not reading at the set point, the method can proceed back to step 330 to take the second device 110 depth to the setpoint.

In step 350, upon determining the primary sensor or the secondary sensor is reading at the set point, the first device 105 can activate a valve that prevents the SCV from going deeper than the setpoint and turn off an adjustment valve.

FIG. 3B is a schematic showing a circuit diagram 300A for the depth control process, according to an embodiment of the present disclosure.

Moving onto the front gangs 220 and the rear gangs 225, the front gangs 220 and the rear gangs 225 can each include, for example, two sensors each and be controlled with feedback from the same type of sensor as is on the depth control circuit. In an embodiment, the rotary position sensor can be connected to a different set of linkages but achieve the same result of magnifying the measured movement so that accuracy and repeatability of the control system is maintained. Both the front gangs 220 and the rear gangs 225 can be independently plumbed circuits. Both the front gangs 220 and the rear gangs 225 can be plumbed in series and include redundant sensors similar to the depth control circuit. The gangs can be independent, but electronically connected when a lock function is selected or engaged.

In an embodiment, the sensors can be placed on the first cylinder and the last cylinder in the cylinder series, which again informs the system 100 when the cylinders are out of phase. When sensor measurements relative to each other are too far apart, the system 100 can again alert the user to rephase the cylinders for the front gangs 220 and/or the rear gangs 225. When one of the two sensors is damaged, then the system 100 can automatically start using the sensor that is still active and control of the front gangs 220 and the rear gangs 225, and the second device 110 can maintain normal operation. The rephase warning, however, will not be active at this time because the system 100 will not be able to detect leakage with only one sensor in the circuit.

In an embodiment, the front gangs 220 and the rear gangs 225 can also be moved together at the same time. The mirrored movement can be performed electronically in the software with a movement lock function. The movement lock function can lock and unlock the front gangs 220 and the rear gangs 225 for synchronous control or independent control. The front gangs 220 and the rear gangs 225 can also be controlled by a separate process that obtains feedback from another sensor, such as LIDAR, radar, or a camera which can be configured to determine clod and residue sizing or residue coverage, which can adjust the angle of the front gangs 220 and the rear gangs 225 to obtain a specific field finish. A soil composition sensor can also be included and used to help determine what angle for the front gangs 220 and the rear gangs 225 should be used. This is because different angles can be used on different types of soils. A soil moisture sensor can also be included and used to vary gang angle so as to aerate the soil more or less depending on the desired amount of moisture retention. This soil moisture data can be sent to the network device 120 for further analysis, as well as layered with other data such as forecasted weather.

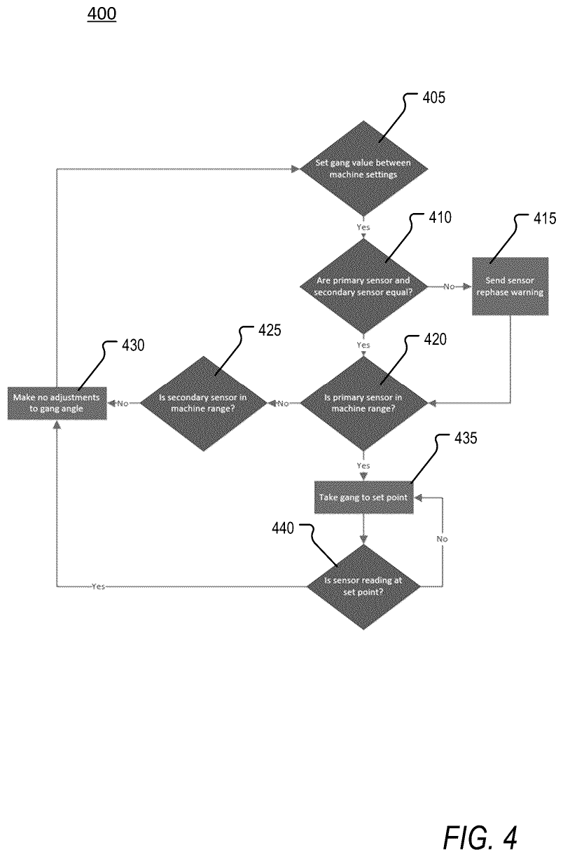

The front gangs 220 and the rear gangs 225 adjustment can be further described with respect to FIG. 4. FIG. 4 is a flow chart for a method 400 of monitoring and adjusting the front gangs 220 and/or the rear gangs 225 of the second device 110, according to an embodiment of the present disclosure.

In an embodiment, in step 405, parameters for the front gangs 220 and/or the rear gangs 225 can be set. The parameters can include, but are not limited to, an angle of the front gangs 220 and/or the rear gangs 225, a depth of the front gangs 220 and/or the rear gangs 225 in the soil (or the blades 205 of the front gangs 220 and/or the rear gangs 225), a width or distance between each of the blades 205, and a down pressure applied to the front gangs 220 and/or the rear gangs 225, among others.

In step 410, the first device 105 can determine whether the primary sensor and the secondary sensor are equal in readings.

In step 415, upon determining the primary sensor and the secondary sensor are not equal in readings, the first device 105 can send a sensor rephase warning to the user.

In step 420, upon determining the primary sensor and the secondary sensor are equal in readings, the first device 105 can determine whether the primary sensor is within range.

In step 425, upon determining the primary sensor reading is not within range, the first device 105 can determine whether a secondary sensor reading is within range.

In step 430, upon determining the secondary sensor voltage is not within range, no adjustments to the angle of the front gangs 220 and/or the rear gangs 225 are performed.

In step 435, upon determining the primary sensor is within range, the angle of the front gangs 220 and/or the rear gangs 225 can be taken to a setpoint set by the user.

In step 440, the first device 105 can determine whether the primary sensor or the secondary sensor is reading at the setpoint. Upon determining the primary sensor or the secondary sensor is not reading at the set point, the method can proceed back to step 435 to take the angle of the front gangs 220 and/or the rear gangs 225 to the setpoint. Upon determining the primary sensor or the secondary sensor is reading at the set point, no additional adjustments are made.

Moving onto the pressure on the star wheels 240, the star wheels 240 pressure circuit may not use a closed loop control circuit in order to operate correctly. In an embodiment, the valve that is used to vary the down pressure can have a specific voltage to pressure output formula that can be used to drive the set pressure. Therefore, the control circuit is not a closed loop like the previously described circuits. The down pressure can be verified by a manual gauge to ensure the system is working properly. If desired, the pressure circuit can include a pressure transducer to measure the pressure digitally to close the control loop. Other sensors, such as a moisture sensor, can be utilized to determine whether the star wheels 240 should be lifted out of the ground in order to keep from plugging with wet soil. A LIDAR, radar, or camera system can be used to determine clod size, which in turn can adjust the amount of down pressure to obtain a desired clod size.

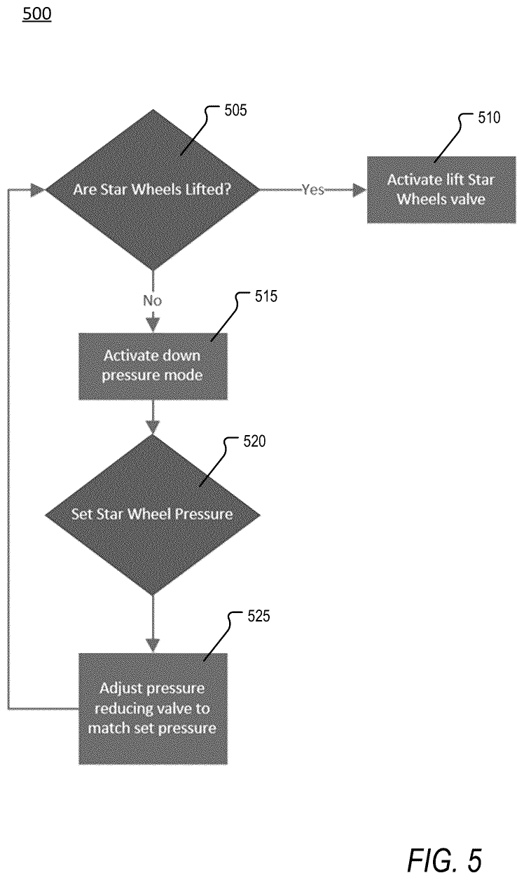

The star wheels 240 adjustment can be further described with respect to FIG. 5. FIG. 5 is a flow chart for a method 500 of monitoring and adjusting the star wheels 240 of the second device 110, according to an embodiment of the present disclosure.

In an embodiment, in step 505, the first device 105 can determine whether the star wheels 240 are lifted.

In step 510, upon determining the star wheels 240 are lifted, the first device 105 can activate the valve to lift the star wheels 240.

In step 515, upon determining the star wheels 240 are not lifted, the first device 105 can activate a down pressure mode.

In step 520, the first device 105 can set the pressure on the star wheels 240.

In step 525, the first device 105 can adjust the pressure reducing valve to match the pressure set.

In an embodiment, the fore and aft leveling can be controlled by the feedback of another rotary position sensor. The rotary position sensor can be connected to the second device 110 with a set of linkages to magnify the movement of the cylinder displacement in order to obtain the set point accurately and reliably. The linkage can be designed to have a linear relationship with the cylinder displacement. This can allow for single point calibration. The leveling can be calibrated at the same time as the depth is being calibrated for where the ground is. This can ensure that the second device 110 is level during work. The set value of the levelness can be a relative scale ranging from −10 to 10. Zero can be considered level after the calibration process, negative numbers can indicate the second device 110 is pitched rearward, and positive numbers can indicate the second device 110 is pitched forward.

In an embodiment, how the second device 110 is set can depend on soil conditions, as one soil may have a better finish with the second device 110 pitched rearward, while another soil condition may have a better finish with the second device 110 pitched forward. The leveling circuit can also use feedback from a load cell or pressure from another circuit in order to give a measured weight distribution from front to rear. The second device 110 can also use LIDAR, radar, or a camera to adjust automatically on rolling terrain to ensure the second device 110 stays level to the ground at all times. The second device 110 can also use other sensors on the tractor 101 like a wheel slip sensor to then decide to increase hitch weight or to reduce hitch weight depending on the situation. A LIDAR, radar, ultrasonic sensor, or camera can be used to determine distance to the ground on the front and rear of the second device 110, which can be used to automatically contour to the ground so as to keep the second device 110 parallel to the ground at all times.

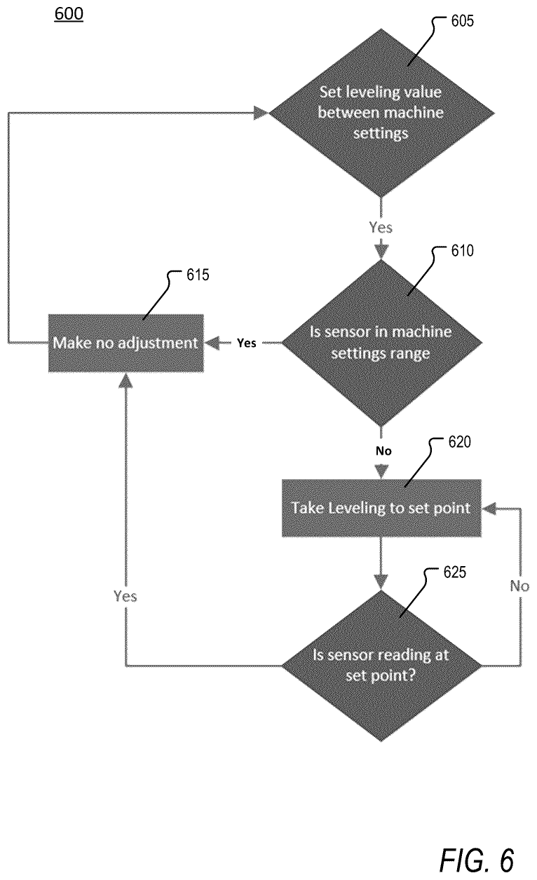

The leveling adjustment can be further described with respect to FIG. 6. FIG. 6 is a flow chart for a method 600 of monitoring and adjusting the level of the second device 110, according to an embodiment of the present disclosure.

In an embodiment, in step 605, the first device 105 can set a leveling value in the settings of the second device 110.

In step 610, the first device 105 can determine whether the sensor reading is within the settings range.

In step 615, upon determining the sensor reading is within the settings range, no adjustments are made to the leveling.

In step 620, upon determining the sensor reading is not within the settings range, the level of the second device 110 can be taken to a setpoint set by the user.

In step 625, the first device 105 can determine whether the sensor is reading at the setpoint. Upon determining the sensor is not reading at the set point, the method can proceed back to step 620 to take the level of the second device 110 to the setpoint. Upon determining the primary sensor or the secondary sensor is reading at the set point, no additional adjustments are made.

The wing 260 down pressure circuit can be very similar to the down pressure circuit of the star wheels 240. The wing 260 down pressure circuit can use the same type of down pressure valve as the star wheels 240 down pressure valve and is also not a closed loop control circuit. The set down pressure can be proportional to the supplied voltage to the valve. This can be verified by the manual pressure gauge that is plumbed into this circuit. The fold and unfold circuit can be controlled traditionally with an SCV in the tractor 101. To ensure that the down pressure circuit does not work against a wing 260 fold operation, a pressure switch can be integrated into the hydraulic manifold that informs the system 100 that the user is attempting to fold the wings 260 so the down pressure circuit should be shut down. The wing 260 down pressure circuit can also include a pressure transducer to make the wing 260 down pressure circuit a closed control loop. Other sensors such as LIDAR, radar, ultrasound, or cameras can be used to determine wing 260 position relative to the ground and adjust wing 260 pressure accordingly to contour to the ground.

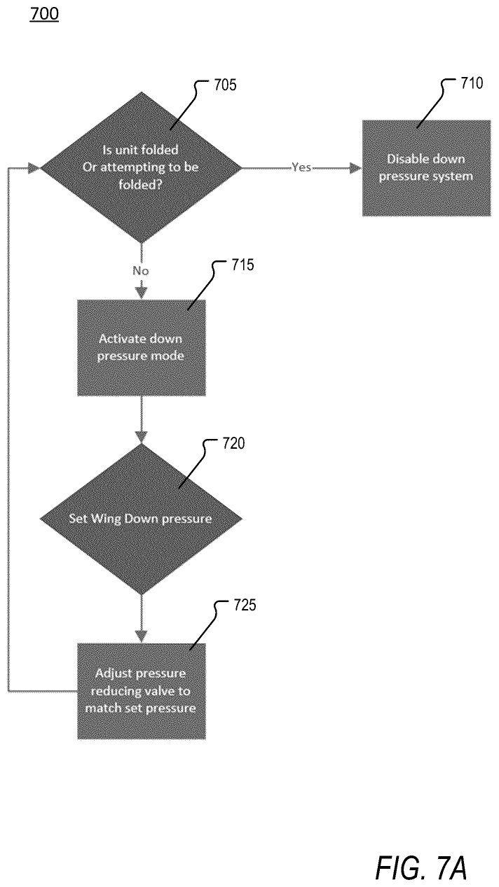

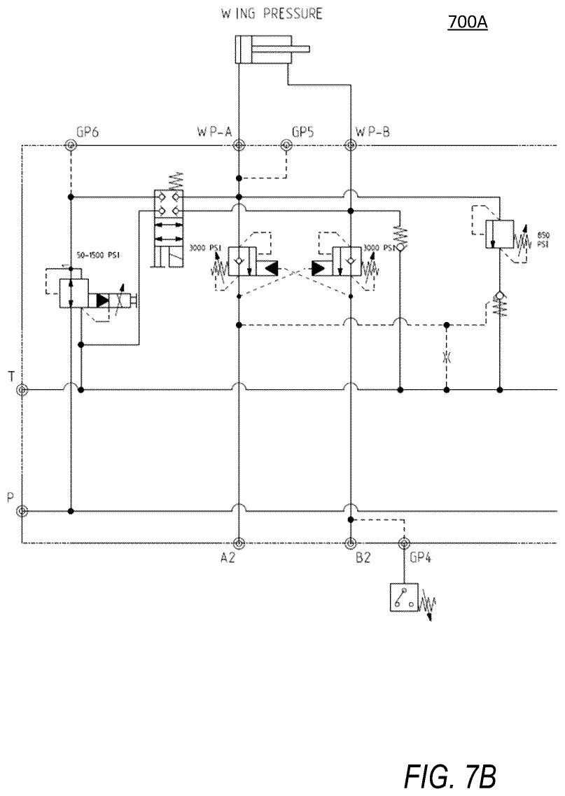

The wing 260 down pressure adjustment can be further described with respect to FIG. 7A. FIG. 7A is a flow chart for a method 700 of monitoring and adjusting the wing 260 down pressure, according to an embodiment of the present disclosure.

In an embodiment, in step 705, the first device 105 can determine whether the wings 260 are folded or attempting to be folded.

In step 710, upon determining the wings 260 are folded or attempting to be folded, the first device 105 can disable the down pressure circuit.

In step 715, upon determining the wings 260 are not folded or attempting to be folded, the first device 105 can activate the down pressure mode.

In step 720, the wings 260 down pressure can be set.

In step 725, the pressure reducing valve can be adjusted to match the set pressure.

FIG. 7B is a schematic showing a circuit diagram 700A for the wings 260 down pressure control process, according to an embodiment of the present disclosure.

In an embodiment, if the user wants to make multiple adjustments at once, the user can save the configuration having the predetermined adjustments to a preset. For example, up to 8 presets can be named and saved within the software. For example, up to 100 presets can be named and saved within the software. The number of presets can be determined by the hardware used to store the presets. For example, more than 100 presets can be named and saved in a cloud storage or server, such as the networked device 120. The presets can be easily accessed on the middle of the work screen in the cab.

In an embodiment, the system 100 can enable a remote operator, such one using the networked device 120, to lock out the user on the first device 105 with an encryption, such as a pin code, password, pass phrase, or lock pattern, among others (or a combination thereof), which will prevent the user from making any manual adjustments to the second device 110. When the preset-only mode is active, it can allow the user to only switch between already defined presets. This can be desirable if a less experienced user is using the implement. For example, the less experienced user can be instructed to use a first preset setting on corn, a second preset setting on wheat, and a third preset setting on soybeans. When locked, the user cannot make any adjustments to the second device 110 besides what is saved as a preset setting already. The user can be prevented from saving new presets, recalibrating the second device 110, setting offsets, changing speed signal input priority, or resetting any maintenance reminders. In order to disable the preset-only mode, the user can need to enter the encryption key that was used to enable the preset-only mode.

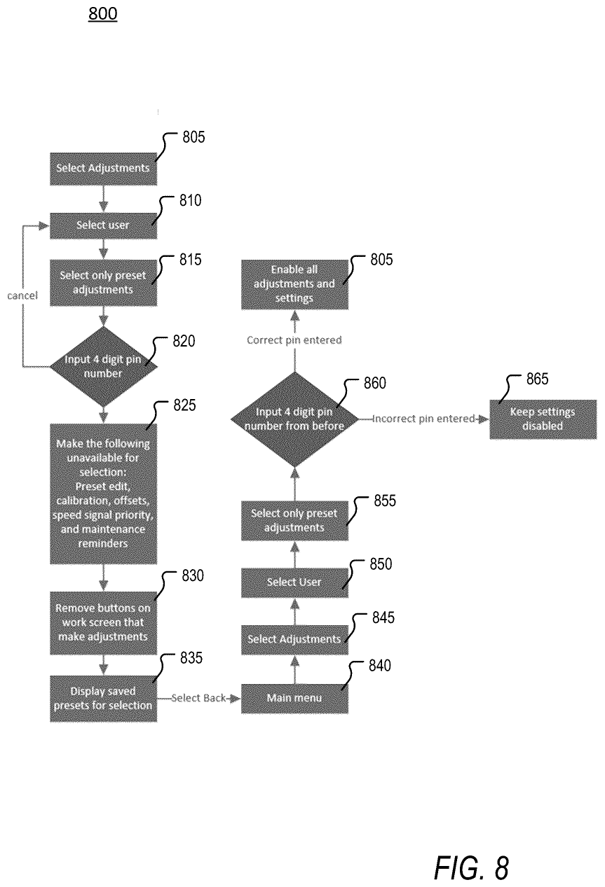

The preset-only mode can be further described with respect to FIG. 8. FIG. 8 is a flow chart for a method 700 of setting preset settings and locking out a user, according to an embodiment of the present disclosure.

In an embodiment, in step 805, adjustment settings can be selected.

In step 810, the user profile can be selected.

In step 815, only preset adjustment settings can be selected.

In step 820, an encryption key, such as a numerical pin, can be input by the user.

In step 825, predetermined functions and settings can be disabled, such as preset edit, calibration, offsets, speed signal priority, and maintenance reminders.

In step 830, buttons on the work screen that can perform the predetermined functions and adjustments can be removed.

In step 835, the presets for selection can be saved and displayed on the work monitor.

In step 840, a main menu screen can be accessed. Here, the software is essentially ready for any user to use since the presets have been defined and the access to adjust the presets has been locked.

In step 845, desired adjustments for the second device 110 can be selected.

In step 850, the user profile, such as the user in the cab attempting to perform the desired adjustments to the second device 110, can be selected.

In step 855, only the preset adjustments can be selected.

In step 860, the encryption key can be input by the user.

In step 865, upon determining the encryption key input is incorrect, the access to adjust settings for the predetermined functions can remain disabled.

In step 870, upon determining the encryption key input is correct, the access to adjust settings for the predetermined functions can be enabled.

In another example of the system 100 using the remote adjustment method with presets, pivot tracks from irrigation systems, which are a relatively small area in comparison to a whole field, can easily be filled in by changing settings on the implement (the second device 110) to pull more soil towards the middle of the second device 110 and push less soil away from the second device 110 with independent angle control of the front gangs 220 and the rear gangs 225. This situation would again likely be ignored without the system 100 using the remote adjustment method with presets or would have to be done as a separate operation afterward. With prescription tillage, the second device 110 can be using a variety of different types of data integrated into an application map to make adjustments in real time. The different data variables can include organic matter composition, soil moisture, compaction, pH, nitrogen, phosphorous, and potassium (NPK) values, or yield maps.

Another benefit of the system 100 using the remote adjustment method with presets is the ability to change settings based on residue coverage. If one part of a field has more residue or more weeds, the user can work more aggressively to get better residue burial or better weed control, while a part of the field that has less residue or less weeds can be worked less aggressively to preserve moisture in the soil. Similarly, this can enable the user and the system 100 to work faster and/or use less fuel. For example, one side of a hill can experience more wind than another side of the hill, thus making residue burial more important on one side versus the other side. For example, on some slopes with predetermined grades, the soil can be prone to erosion, so the tillage operation can be tailored to be less aggressive. In myriad scenarios and example situations, the system 100 using the remote adjustment method with presets can provide an efficient solution by quickly being able to switch to desired settings on-the-go. With presets, a user can name and save a complete set of adjustments so that multiple adjustments will occur with the touch of a button, thus saving time, reducing errors, and resulting in adjustments being actually performed to optimize the system 100 for the predetermined field and product.

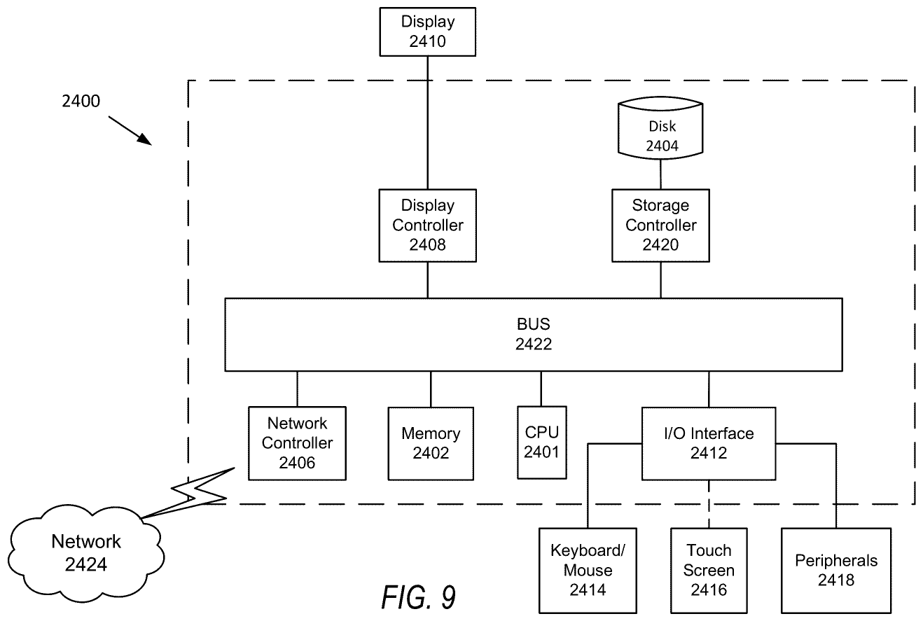

FIG. 9 is a block diagram of a hardware description of a computer 2400 used in exemplary embodiments. In the embodiments, computer 2400 can be a desktop, laptop, or server. Computer 2400 can perform the functions of the first device 105 or the networked device 120 shown in FIG. 1, or one or more client devices.

In FIG. 9, the computer 2400 includes a CPU 2401 which performs the processes described herein. The process data and instructions may be stored in memory 2402. These processes and instructions may also be stored on a storage medium disk 2404 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer 2400 communicates, such as a server or computer.

Further, the claimed advancements may be provided as a utility application, background daemon, or component of an operating system, or combination thereof, executing in conjunction with CPU 2401 and an operating system such as Microsoft® Windows®, UNIX®, Oracle® Solaris, LINUX®, Apple macOS® and other systems known to those skilled in the art.

In order to achieve the computer 2400, the hardware elements may be realized by various circuitry elements, known to those skilled in the art. For example, CPU 2401 may be a Xenon® or Core® processor from Intel Corporation of America or an Opteron® processor from AMD of America, or may be other processor types that would be recognized by one of ordinary skill in the art. Alternatively, the CPU 2401 may be implemented on an FPGA, ASIC, PLD or using discrete logic circuits, as one of ordinary skill in the art would recognize. Further, CPU 2401 may be implemented as multiple processors cooperatively working in parallel to perform the instructions of the inventive processes described above.

The computer 2400 in FIG. 9 also includes a network controller 2406, such as an Intel Ethernet PRO network interface card from Intel Corporation of America, for interfacing with network 2424 or the network 150 of FIG. 1. As can be appreciated, the network 2424 can be a public network, such as the Internet, or a private network such as LAN or WAN network, or any combination thereof and can also include PSTN or ISDN sub-networks. The network 2424 can also be wired, such as an Ethernet network, or can be wireless such as a cellular network including EDGE, 3G and 4G wireless cellular systems. The wireless network can also be WiFi®, Bluetooth®, or any other wireless form of communication that is known.

The computer 2400 further includes a display controller 2408, such as a NVIDIA® GeForce® GTX or Quadro® graphics adaptor from NVIDIA Corporation of America for interfacing with display 2410, such as a Hewlett Packard® HPL2445w LCD monitor. A general purpose I/O interface 2412 interfaces with a keyboard and/or mouse 2414 as well as an optional touch screen panel 2416 on or separate from display 2410. General purpose I/O interface 2412 also connects to a variety of peripherals 2418 including printers and scanners, such as an OfficeJet® or DeskJet® from Hewlett Packard.

The general purpose storage controller 2420 connects the storage medium disk 2404 with communication bus 2422, which may be an ISA, EISA, VESA, PCI, or similar, for interconnecting all of the components of the computer 2400. A description of the general features and functionality of the display 2410, keyboard and/or mouse 2414, as well as the display controller 2408, storage controller 2420, network controller 2406, and general purpose I/O interface 2412 is omitted herein for brevity as these features are known.

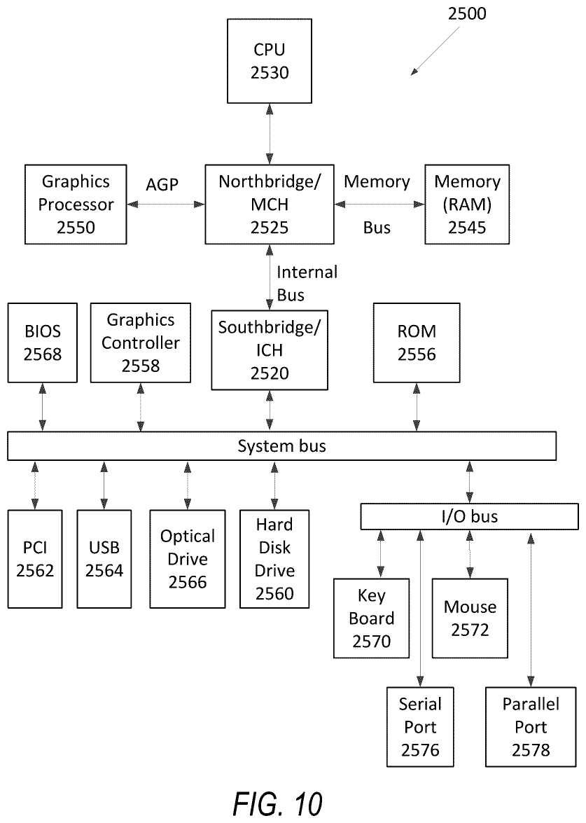

FIG. 10 is a schematic diagram of an exemplary data processing system, according to an embodiment of the present disclosure. The data processing system is an example of a computer in which code or instructions implementing the processes of the illustrative embodiments can be located.

In FIG. 10, data processing system 2500 employs an application architecture including a north bridge and memory controller hub (NB/MCH) 2525 and a south bridge and input/output (I/O) controller hub (SB/ICH) 2520. The central processing unit (CPU) 2530 is connected to NB/MCH 2525. The NB/MCH 2525 also connects to the memory 2545 via a memory bus, and connects to the graphics processor 2550 via an accelerated graphics port (AGP). The NB/MCH 2525 also connects to the SB/ICH 2520 via an internal bus (e.g., a unified media interface or a direct media interface). The CPU 2530 can contain one or more processors and even can be implemented using one or more heterogeneous processor systems.

Referring again to FIG. 10, the data processing system 2500 can include the SB/ICH 2520 being coupled through a system bus to an I/O Bus, a read only memory (ROM) 2556, universal serial bus (USB) port 2564, a flash binary input/output system (BIOS) 2568, and a graphics controller 2558. PCI/PCIe devices can also be coupled to SB/ICH 2520 through a PCI bus 2562.

The PCI devices can include, for example, Ethernet adapters, add-in cards, and PC cards for notebook computers. The Hard disk drive 2560 and CD-ROM 2566 can use, for example, an integrated drive electronics (IDE) or serial advanced technology attachment (SATA) interface. In one implementation the I/O bus can include a super I/O (SIO) device.

Further, the hard disk drive (HDD) 2560 and optical drive 2566 can also be coupled to the SB/ICH 2520 through a system bus. In one implementation, a keyboard 2570, a mouse 2572, a parallel port 2578, and a serial port 2576 can be connected to the system bus through the I/O bus. Other peripherals and devices can be connected to the SB/ICH 2520 using a mass storage controller such as SATA or PATA, an Ethernet port, an ISA bus, a LPC bridge, SMBus, a DMA controller, and an Audio Codec.

A system includes an implement including a first set of material manipulators configured to manipulate the material on the ground surface, a second set of material manipulators being independently adjustable from the first set of material manipulators and configured to manipulate the material on the ground surface, a first set of sensors configured to monitor a set of parameters of the first set of material manipulators, a second set of sensors configured to monitor a set of parameters of the second set of material manipulators, a first set of actuators configured to adjust the set of parameters of the first set of material manipulators, and a second set of actuators configured to adjust the set of parameters of the second set of material manipulators, and a first device disposed in a vehicle, the vehicle mechanically and electrically coupled to the implement, the first device communicatively coupled to the first set of sensors, the second set of sensors, the first set of actuators, and the second set of actuators, the first set of sensors and the second set of sensors configured to transmit the monitored set of parameters to the first device, the first device including processing circuitry configured to receive, from the implement, the transmitted monitored set of parameters of the first set of material manipulators and the second set of material manipulators, determine whether the first set of material manipulators or the second set of material manipulators is within a predetermined range of a parameter setpoint, and upon determining the first set of material manipulators or the second set of material manipulators is not within the predetermined range of the parameter setpoint, actuate the first set of actuators to adjust the first set of material manipulators or the second set of actuators to adjust the second set of material manipulators, wherein actuating the first set of actuators or the second set of actuators can be performed independently.

In an embodiment, the parameter setpoint for the first set of material manipulators is an angle setpoint and the parameter setpoint for the second set of material manipulators is an angle setpoint, the angle setpoint of the first set of material manipulators is independent of the angle setpoint of the second set of material manipulators, and the processing circuitry is further configured to adjust the first set of material manipulators via the first set of actuators to arrange the first set of material manipulators within the predetermined range of the angle setpoint of the first set of material manipulators independently from the second set of material manipulators.

In an embodiment, the first set of sensors includes a first sensor and a second sensor, the first sensor configured to monitor a first portion of the first set of material manipulators and the second sensor configured to monitor a second portion of the first set of material manipulators, and the processing circuitry is further configured to upon determining the first sensor is disabled and unable to transmit the monitored set of parameters for the first portion of the first set of material manipulators, adjust the first set of material manipulators based on the transmitted set of parameters monitored by the second sensor for the second portion of the first set of material manipulators.

In an embodiment, the first set of material manipulators includes a first set of circular blades attached to a first axle and configured to rotate around an axis of the first axle, the first axle being mounted to a frame of the implement towards a first end of the implement, the second set of material manipulators includes a second set of circular blades attached to a second axle and configured to rotate around an axis of the second axle, the second axle being mounted to the frame of the implement towards a second end of the implement, a plane of the first set of circular blades and a plane of the second set of the circular blades being oriented in a direction spanning the first end and the second end of the implement, and the parameter setpoint is a depth setpoint of the first set of circular blades and the second set of circular blades.

In an embodiment, the first set of actuators and the second set of actuators are hydraulic actuators, the first set of sensors and the second set of sensors are rotary position sensors attached to linkages connected to the hydraulic first set of actuators and the hydraulic second set of actuators, and the rotary position sensors are configured to measure a relative distance between a wheel attached to the implement and the frame of the implement to determine a depth of the first set of circular blades and a depth of the second set of circular blades in the ground surface.

In an embodiment, the processing circuitry is further configured to receive an input from a user, and upon receiving an input from the user to lock the adjustment of the first set of material manipulators to the second set of material manipulators, lock the relative orientation of the first set of material manipulators to the second set of material manipulators.

In an embodiment, the processing circuitry is further configured to determine an orientation of the implement relative to a ground level via a calibration, and actuate the first set of actuators to adjust the depth of the first set of material manipulators or the second set of actuators to adjust the depth of the second set of material manipulators based on the determined orientation of the implement via the calibration.

In an embodiment, the processing circuitry is further configured to determine, based on the determined orientation of the implement via the calibration, a depth of the first set of material manipulators and the second set of material manipulators relative to the ground surface, and stop the adjustment of the first set of material manipulators and the second set of material manipulators before the depth of the first set of material manipulators and the second set of material manipulator exceeds the depth setpoint.

In an embodiment, the processing circuitry is further configured to display a preset adjustment profile to a user, the preset adjustment profile including preset parameter setpoints for the first set of material manipulators and the second set of material manipulators, receive, from the user, a selection indicating a desired preset adjustment profile, and transmit the desired preset adjustment profile to the implement, the implement adjusting the first set of material manipulators and the second set of material manipulators to the preset parameter setpoints.

In an embodiment, the system further includes a networked device communicatively connected to the first device and operated by a remote operator, wherein the processing circuitry is further configured to receive, from the remote operator, an instruction to encrypt access to settings corresponding to the preset adjustment profile, and encrypt the preset adjustment profile with an encryption.

In an embodiment, the processing circuitry is further configured to adjust the first set of material manipulators and the second set of material manipulators using a proportional flow control valve configured to lower the first set of material manipulators or the second set of material manipulators quicker when the first set of material manipulators or the second set of material manipulators is further away from the depth setpoint and gradually get slower as the first set of material manipulators or the second set of material manipulators gets very close to the depth setpoint.

In an embodiment, the processing circuitry is further configured to receive, from the user, an encryption key corresponding to a predetermined user profile, determine whether the encryption key is valid for the corresponding predetermined user profile, upon determining the encryption key is valid for the corresponding predetermined user profile, determine whether the predetermined user profile has access to the settings corresponding to the preset adjustment profile, and upon determining the determined user profile has access to the settings corresponding to the preset adjustment profile, display the settings for adjusting the preset adjustment profile.

A method includes receiving, from the implement including a first set of material manipulators configured to manipulate the material on the ground surface, a second set of material manipulators being independently adjustable from the first set of material manipulators and configured to manipulate the material on the ground surface, a first set of sensors configured to monitor a set of parameters of the first set of material manipulators, a second set of sensors configured to monitor a set of parameters of the second set of material manipulators, a first set of actuators configured to adjust the set of parameters of the first set of material manipulators, and a second set of actuators configured to adjust the set of parameters of the second set of material manipulators, a transmitted monitored set of parameters of the first set of material manipulators and the second set of material manipulators; determining whether the first set of material manipulators or the second set of material manipulators is within a predetermined range of a parameter setpoint; and upon determining the first set of material manipulators or the second set of material manipulators is not within the predetermined range of the parameter setpoint, actuating the first set of actuators to adjust the first set of material manipulators or the second set of actuators to adjust the second set of material manipulators, wherein actuating the first set of actuators or the second set of actuators can be performed independently.

In an embodiment, the parameter setpoint for the first set of material manipulators is an angle setpoint and the parameter setpoint for the second set of material manipulators is an angle setpoint, the angle setpoint of the first set of material manipulators is independent of the angle setpoint of the second set of material manipulators, and the method further comprises adjusting the first set of material manipulators via the first set of actuators to arrange the first set of material manipulators within the predetermined range of the angle setpoint of the first set of material manipulators independently from the second set of material manipulators.

In an embodiment, the first set of sensors includes a first sensor and a second sensor, the first sensor configured to monitor a first portion of the first set of material manipulators and the second sensor configured to monitor a second portion of the first set of material manipulators, and the method further comprises upon determining the first sensor is disabled and unable to transmit the monitored set of parameters for the first portion of the first set of material manipulators, adjusting the first set of material manipulators based on the transmitted set of parameters monitored by the second sensor for the second portion of the first set of material manipulators.

In an embodiment, the first set of material manipulators includes a first set of circular blades attached to a first axle and configured to rotate around an axis of the first axle, the first axle being mounted to a frame of the implement towards a first end of the implement, the second set of material manipulators includes a second set of circular blades attached to a second axle and configured to rotate around an axis of the second axle, the second axle being mounted to the frame of the implement towards a second end of the implement, a plane of the first set of circular blades and a plane of the second set of the circular blades being oriented in a direction spanning the first end and the second end of the implement, and the parameter setpoint is a depth setpoint of the first set of circular blades and the second set of circular blades.

In an embodiment, the first set of actuators and the second set of actuators are hydraulic actuators, the first set of sensors and the second set of sensors are rotary position sensors attached to linkages connected to the hydraulic first set of actuators and the hydraulic second set of actuators, and the rotary position sensors are configured to measure a relative distance between a wheel attached to the implement and the frame of the implement to determine a depth of the first set of circular blades and a depth of the second set of circular blades in the ground surface.

In an embodiment, the method further includes receiving an input from a user; and upon receiving an input from the user to lock the adjustment of the first set of material manipulators to the second set of material manipulators, locking the relative orientation of the first set of material manipulators to the second set of material manipulators.

In an embodiment, the method further includes determining an orientation of the implement relative to a ground level via a calibration; and actuating the first set of actuators to adjust the depth of the first set of material manipulators or the second set of actuators to adjust the depth of the second set of material manipulators based on the determined orientation of the implement via the calibration.

In an embodiment, the method further includes determining, based on the determined orientation of the implement via the calibration, a depth of the first set of material manipulators and the second set of material manipulators relative to the ground surface; and stop the adjustment of the first set of material manipulators and the second set of material manipulators before the depth of the first set of material manipulators and the second set of material manipulator exceeds the depth setpoint.

In an embodiment, the method further includes displaying a preset adjustment profile to a user, the preset adjustment profile including preset parameter setpoints for the first set of material manipulators and the second set of material manipulators; receiving, from the user, a selection indicating a desired preset adjustment profile; and transmitting the desired preset adjustment profile to the implement, the implement adjusting the first set of material manipulators and the second set of material manipulators to the preset parameter setpoints.

In an embodiment, the method further includes receiving, from a remote operator operating a networked device, an instruction to encrypt access to settings corresponding to the preset adjustment profile; and encrypting the preset adjustment profile with an encryption.

In an embodiment, the method further includes adjusting the first set of material manipulators and the second set of material manipulators using a proportional flow control valve configured to lower the first set of material manipulators or the second set of material manipulators quicker when the first set of material manipulators or the second set of material manipulators is further away from the depth setpoint and gradually get slower as the first set of material manipulators or the second set of material manipulators gets very close to the depth setpoint.

In an embodiment, the method further includes receiving, from the user, an encryption key corresponding to a predetermined user profile, determining whether the encryption key is valid for the corresponding predetermined user profile, upon determining the encryption key is valid for the corresponding predetermined user profile, determining whether the predetermined user profile has access to the settings corresponding to the preset adjustment profile, and upon determining the determined user profile has access to the settings corresponding to the preset adjustment profile, displaying the settings for adjusting the preset adjustment profile.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. A system for manipulating material on a ground surface, comprising:
an implement including
a first set of material manipulators configured to manipulate the material on the ground surface,
a second set of material manipulators being independently adjustable from the first set of material manipulators and configured to manipulate the material on the ground surface,
a first set of sensors configured to monitor a set of parameters of the first set of material manipulators,
a second set of sensors configured to monitor a set of parameters of the second set of material manipulators,
a first set of actuators configured to adjust the set of parameters of the first set of material manipulators, and
a second set of actuators configured to adjust the set of parameters of the second set of material manipulators, and
a first device disposed in a vehicle, the vehicle mechanically and electrically coupled to the implement, the first device communicatively coupled to the first set of sensors, the second set of sensors, the first set of actuators, and the second set of actuators, the first set of sensors and the second set of sensors configured to transmit the monitored set of parameters to the first device, the first device including processing circuitry configured to
receive, from the implement, the transmitted monitored set of parameters of the first set of material manipulators and the second set of material manipulators,
determine whether the first set of material manipulators or the second set of material manipulators is within a predetermined range of a parameter setpoint, and
upon determining the first set of material manipulators or the second set of material manipulators is not within the predetermined range of the parameter setpoint, actuate the first set of actuators to adjust the first set of material manipulators or the second set of actuators to adjust the second set of material manipulators, wherein actuating the first set of actuators or the second set of actuators can be performed independently.

2. The system of claim 1, wherein
the parameter setpoint for the first set of material manipulators is an angle setpoint and the parameter setpoint for the second set of material manipulators is an angle setpoint,
the angle setpoint of the first set of material manipulators is independent of the angle setpoint of the second set of material manipulators, and
the processing circuitry is further configured to adjust the first set of material manipulators via the first set of actuators to arrange the first set of material manipulators within the predetermined range of the angle setpoint of the first set of material manipulators independently from the second set of material manipulators.

3. The system of claim 1, wherein
the first set of sensors includes a first sensor and a second sensor, the first sensor configured to monitor a first portion of the first set of material manipulators and the second sensor configured to monitor a second portion of the first set of material manipulators, and
the processing circuitry is further configured to upon determining the first sensor is disabled and unable to transmit the monitored set of parameters for the first portion of the first set of material manipulators, adjust the first set of material manipulators based on the transmitted set of parameters monitored by the second sensor for the second portion of the first set of material manipulators.

4. The system of claim 1, wherein
the first set of material manipulators includes a first set of circular blades attached to a first axle and configured to rotate around an axis of the first axle, the first axle being mounted to a frame of the implement towards a first end of the implement,
the second set of material manipulators includes a second set of circular blades attached to a second axle and configured to rotate around an axis of the second axle, the second axle being mounted to the frame of the implement towards a second end of the implement, a plane of the first set of circular blades and a plane of the second set of the circular blades being oriented in a direction spanning the first end and the second end of the implement, and
the parameter setpoint is a depth setpoint of the first set of circular blades and the second set of circular blades.

5. The system of claim 4, wherein
the first set of actuators and the second set of actuators are hydraulic actuators,
the first set of sensors and the second set of sensors are rotary position sensors attached to linkages connected to the hydraulic first set of actuators and the hydraulic second set of actuators, and
the rotary position sensors are configured to measure a relative distance between a wheel attached to the implement and the frame of the implement to determine a depth of the first set of circular blades and a depth of the second set of circular blades in the ground surface.

6. The system of claim 4, wherein the processing circuitry is further configured to
receive an input from a user, and
upon receiving an input from the user to lock the adjustment of the first set of material manipulators to the second set of material manipulators, lock the relative orientation of the first set of material manipulators to the second set of material manipulators.

7. The system of claim 4, wherein the processing circuitry is further configured to
determine an orientation of the implement relative to a ground level via a calibration, and
actuate the first set of actuators to adjust the depth of the first set of material manipulators or the second set of actuators to adjust the depth of the second set of material manipulators based on the determined orientation of the implement via the calibration.

8. The system of claim 7, wherein the processing circuitry is further configured to
determine, based on the determined orientation of the implement via the calibration, a depth of the first set of material manipulators and the second set of material manipulators relative to the ground surface, and
stop the adjustment of the first set of material manipulators and the second set of material manipulators before the depth of the first set of material manipulators and the second set of material manipulator exceeds the depth setpoint.

9. The system of claim 1, wherein the processing circuitry is further configured to
display a preset adjustment profile to a user, the preset adjustment profile including preset parameter setpoints for the first set of material manipulators and the second set of material manipulators,
receive, from the user, a selection indicating a desired preset adjustment profile, and
transmit the desired preset adjustment profile to the implement, the implement adjusting the first set of material manipulators and the second set of material manipulators to the preset parameter setpoints.

10. The system of claim 1, further comprising a networked device communicatively connected to the first device and operated by a remote operator, wherein the processing circuitry is further configured to
receive, from the remote operator, an instruction to encrypt access to settings corresponding to the preset adjustment profile, and
encrypt the preset adjustment profile with an encryption.

11. A method of adjusting an implement for manipulating material in a ground surface, comprising:
receiving, from the implement including a first set of material manipulators configured to manipulate the material on the ground surface, a second set of material manipulators being independently adjustable from the first set of material manipulators and configured to manipulate the material on the ground surface, a first set of sensors configured to monitor a set of parameters of the first set of material manipulators, a second set of sensors configured to monitor a set of parameters of the second set of material manipulators, a first set of actuators configured to adjust the set of parameters of the first set of material manipulators, and a second set of actuators configured to adjust the set of parameters of the second set of material manipulators, a transmitted monitored set of parameters of the first set of material manipulators and the second set of material manipulators;
determining whether the first set of material manipulators or the second set of material manipulators is within a predetermined range of a parameter setpoint; and
upon determining the first set of material manipulators or the second set of material manipulators is not within the predetermined range of the parameter setpoint, actuating the first set of actuators to adjust the first set of material manipulators or the second set of actuators to adjust the second set of material manipulators, wherein actuating the first set of actuators or the second set of actuators can be performed independently.

12. The method of claim 11, wherein
the parameter setpoint for the first set of material manipulators is an angle setpoint and the parameter setpoint for the second set of material manipulators is an angle setpoint,
the angle setpoint of the first set of material manipulators is independent of the angle setpoint of the second set of material manipulators, and
the method further comprises adjusting the first set of material manipulators via the first set of actuators to arrange the first set of material manipulators within the predetermined range of the angle setpoint of the first set of material manipulators independently from the second set of material manipulators.

13. The method of claim 11, wherein
the first set of sensors includes a first sensor and a second sensor, the first sensor configured to monitor a first portion of the first set of material manipulators and the second sensor configured to monitor a second portion of the first set of material manipulators, and
the method further comprises upon determining the first sensor is disabled and unable to transmit the monitored set of parameters for the first portion of the first set of material manipulators, adjusting the first set of material manipulators based on the transmitted set of parameters monitored by the second sensor for the second portion of the first set of material manipulators.

14. The method of claim 11, wherein
the first set of material manipulators includes a first set of circular blades attached to a first axle and configured to rotate around an axis of the first axle, the first axle being mounted to a frame of the implement towards a first end of the implement,
the second set of material manipulators includes a second set of circular blades attached to a second axle and configured to rotate around an axis of the second axle, the second axle being mounted to the frame of the implement towards a second end of the implement, a plane of the first set of circular blades and a plane of the second set of the circular blades being oriented in a direction spanning the first end and the second end of the implement, and
the parameter setpoint is a depth setpoint of the first set of circular blades and the second set of circular blades.

15. The method of claim 14, wherein
the first set of actuators and the second set of actuators are hydraulic actuators,
the first set of sensors and the second set of sensors are rotary position sensors attached to linkages connected to the hydraulic first set of actuators and the hydraulic second set of actuators, and
the rotary position sensors are configured to measure a relative distance between a wheel attached to the implement and the frame of the implement to determine a depth of the first set of circular blades and a depth of the second set of circular blades in the ground surface.

16. The method of claim 14, further comprising
receiving an input from a user; and
upon receiving an input from the user to lock the adjustment of the first set of material manipulators to the second set of material manipulators, locking the relative orientation of the first set of material manipulators to the second set of material manipulators.

17. The method of claim 14, further comprising
determining an orientation of the implement relative to a ground level via a calibration; and
actuating the first set of actuators to adjust the depth of the first set of material manipulators or the second set of actuators to adjust the depth of the second set of material manipulators based on the determined orientation of the implement via the calibration.

18. The method of claim 17, further comprising
determining, based on the determined orientation of the implement via the calibration, a depth of the first set of material manipulators and the second set of material manipulators relative to the ground surface; and
stop the adjustment of the first set of material manipulators and the second set of material manipulators before the depth of the first set of material manipulators and the second set of material manipulator exceeds the depth setpoint.

19. The method of claim 11, further comprising
displaying a preset adjustment profile to a user, the preset adjustment profile including preset parameter setpoints for the first set of material manipulators and the second set of material manipulators;
receiving, from the user, a selection indicating a desired preset adjustment profile; and
transmitting the desired preset adjustment profile to the implement, the implement adjusting the first set of material manipulators and the second set of material manipulators to the preset parameter setpoints.

20. The method of claim 11, further comprising
receiving, from a remote operator operating a networked device, an instruction to encrypt access to settings corresponding to the preset adjustment profile; and
encrypting the preset adjustment profile with an encryption.
